(19) United States
(12) Patent Application Publication
(10) Pub. No.: US 2014/0227533 A1
(43) Pub. Date: Aug. 14, 2014

(54) LAMINATE BODY AND METHOD FOR PRODUCING LAMINATE BODY

(71) Applicant: DAIKIN INDUSTRIES, LTD., Osaka-shi, Osaka (JP)

(72) Inventors: Shinya Murakami, Settsu-shi (JP); Hiroyuki Yoshimoto, Settsu-shi (JP); Takeshi Inaba, Settsu-shi (JP); Masamichi Sukegawa, Settsu-shi (JP); Yasuyuki Yamaguchi, Settsu-shi (JP)

(73) Assignee: DAIKIN INDUSTRIES, LTD., Osaka-shi, Osaka (JP)

(21) Appl. No.: 14/346,429

(22) PCT Filed: Sep. 21, 2012
(86) PCT No.: PCT/JP2012/074279

§ 371 Date: Mar. 21, 2014

(30) Foreign Application Priority Data
Sep. 22, 2011 (JP) 2011-208047

(51) Int. Cl. B32B 15/082; H01B 13/22

(52) U.S. Cl. CPC B32B 15/082; H01B 13/22
USPC 428/421; 156/51; 156/60

(57) ABSTRACT

The present invention aims to provide a laminate in which a metal and a fluoropolymer are directly and firmly attached to each other. The present invention relates to a laminate including a layer (A) including a metal, and a layer (B) formed on the layer (A), wherein the layer (B) includes a copolymer containing a polymer unit based on tetrafluoroethylene and a polymer unit based on a perfluoro(alkyl vinyl ether), the copolymer contains a carboxyl group at a terminus of a main chain and has a melt flow rate of not lower than 20 g/10 min and a melting point of not higher than 295° C., and the metal is at least one selected from the group consisting of copper, stainless steel, aluminum, iron, and an alloy thereof.

### TECHNICAL FIELD

The present invention relates to a laminate and a method of producing a laminate.

### BACKGROUND ART

A tetrafluoroethylene/perfluoro(alkyl vinyl ether) copolymer is a fluoropolymer that is excellent in mechanical properties, chemical properties, and electrical properties, and is melt-processible.

Patent Literature 1 discloses, as a tetrafluoroethylene/perfluoro(alkyl vinyl ether) copolymer excellent in mechanical properties and injection-molding properties, a tetrafluoroethylene/perfluoro(alkyl vinyl ether) copolymer that consists of a polymer unit (A) based on tetrafluoroethylene and a polymer unit (B) based on a perfluoro(alkyl vinyl ether) and has a molar ratio (A)/(B) of 98.1/1.9 to 95.0/5.0, a melt flow rate at 372° C. of 35 to 60 g/10 min, and a ratio M_{w}/Mₙ (M_{w}: weight average molecular weight, Mₙ: number average molecular weight) of 1 to 1.7.

Patent Literature 2 discloses a fluororesin containing a tetrafluoroethylene/perfluoro(alkyl vinyl ether) copolymer with a melt flow rate at 372° C. of more than 60 (g/10 min) as a fluororesin with excellent thin-wall formability, which can be formed into a wire-coating material that has good flame retardance, good heat resistance, and good electrical properties.

However, fluoropolymers such as a tetrafluoroethylene/perfluoro(alkyl vinyl ether) copolymer originally have low adhesiveness. Thus, it is difficult to attach such a fluoropolymer directly to another material (base material). Even by thermal fusion bonding, fluoropolymers often show insufficient adhesive strength. Even in the case where a fluoropolymer is attached to another material (base material) with certain adhesiveness, the adhesiveness tends to vary depending on the kind of the base material or the way of lamination. Thus, fluoropolymers often have failed to achieve reliability in adhesiveness.

To solve these problems, Patent Literature 3 proposes that a hydroxyl group is introduced into a fluoropolymer by copolymerization of a hydroxyl group-containing fluoroethylene monomer. Thereby, the fluoropolymer is directly given excellent adhesiveness to various materials to which fluoropolymers have had insufficient adhesiveness or no adhesiveness, without processing such as surface treatment.

Patent Literature 4 discloses a laminated substrate of a heat-resistant resin, which is formed by laminating a metal foil and a thermoplastic resin that includes an inorganic element such as an ion or a halogen and has a glass transition point of not lower than 260° C. and self-weldability.

### CITATION LIST

### Patent Literature

Patent Literature 1: JP 2002-53620 A
Patent Literature 2: WO 2005/052015
Patent Literature 3: WO 97/21779
Patent Literature 4: JP 4-53186 A

### SUMMARY OF INVENTION

### Technical Problem

However, the techniques disclosed in Patent Literature 3 and 4 still provide insufficient adhesiveness between a metal and a fluoropolymer. Thus, in a product such as a printed circuit board, which is used for various transmission apparatuses that transmit high frequency signals, the surface of the metal included in the product is roughened to enhance the adhesiveness between the metal and a fluoropolymer. Such a roughened surface of a metal, however, adversely affects high frequency transmission.

The present invention aims to solve the conventional problems and to provide a laminate in which a metal and a fluoropolymer are directly and firmly attached to each other.

### Solution to Problem

The present inventors found that, among fluoropolymers, a copolymer containing tetrafluoroethylene and a perfluoro(alkyl vinyl ether) with a limited melt flow rate can firmly adhere to metal, and thus completed the present invention.

One aspect of the present invention provides a laminate including a layer (A) including a metal, and a layer (B) formed on the layer (A), wherein the layer (B) includes a copolymer containing a polymer unit based on tetrafluoroethylene and a polymer unit based on a perfluoro(alkyl vinyl ether), the copolymer contains a carboxyl group at a terminus of a main chain and has a melt flow rate of not lower than 20 g/10 min and a melting point of not higher than 295° C., and the metal is at least one selected from the group consisting of copper, stainless steel, aluminum, iron, and an alloy thereof.

The copolymer preferably contains not less than 50 carboxyl groups per 10⁶ main chain carbon atoms.

In addition, the laminate of the present invention preferably further includes a layer (C) formed on the layer (B), and the layer (C) preferably includes at least one polymer selected from the group consisting of a tetrafluoroethylene homopolymer and modified polytetrafluoroethylenes having a modified ratio of not more than 1 mass %.

The laminate of the present invention is preferably a printed circuit board.

The laminate of the present invention is preferably a motor coil wire.

Another aspect of the present invention provides a push-pull cable including the laminate of the present invention.

Another aspect of the present invention also provides a method of producing a laminate, including heat pressing a metal and a sheet, wherein the sheet includes a copolymer containing a polymer unit based on tetrafluoroethylene and a polymer unit based on a perfluoro(alkyl vinyl ether), the copolymer contains a carboxyl group at a terminus of a main chain and has a melt flow rate of not lower than 20 g/10 min and a melting point of not higher than 295° C., and the metal is at least one selected from the group consisting of copper, stainless steel, aluminum, iron, and an alloy thereof.

The present invention also provides a method of producing a laminate, including covering/molding a core wire including a metal with a copolymer, wherein the copolymer contains a polymer unit based on tetrafluoroethylene and a polymer unit based on a perfluoro(alkyl vinyl ether), the copolymer contains a carboxyl group at a terminus of a main chain and has a melt flow rate of not lower than 20 g/10 min and a melting point of not higher than 295° C., and the metal is at least one selected from the group consisting of copper, stainless steel, aluminum, iron, and an alloy thereof.

### Advantageous Effects of Invention

According to the laminate of the present invention, a metal and a fluoropolymer are directly and firmly attached to each other even if a surface of the metal is not be roughened.

### DESCRIPTION OF EMBODIMENTS

The laminate of the present invention includes a layer (A) including a metal and a layer (B) formed on the layer (A).

The metal is at least one selected from the group consisting of copper, stainless steel, aluminum, iron, and an alloy thereof. A metal selected from the above enables firm attachment between the layer (A) and the layer (B). The metal is preferably at least one selected from the group consisting of copper, stainless steel, and aluminum, and is more preferably copper.

Examples of the stainless steel include austenitic stainless steels, martensitic stainless steels, and ferritic stainless steels.

Examples of the layer (A) including a metal include metal foil, a metal core wire, and a metal plate.

For example, if the laminate of the present invention is the below-mentioned printed circuit board, the layer (A) is a metal foil. The metal foil has a thickness of typically 5 to 200 μm, and preferably 8 to 50 μm.

If the laminate of the present invention is a coil wire, an electric wire, a cable, or the like, the layer (A) is a core wire including a metal. The core wire has a diameter of typically 0.03 to 2 mm, and preferably 0.5 to 2 mm.

The layer (B) includes a copolymer (PFA) containing a polymer unit (TFE unit) based on tetrafluoroethylene and a polymer unit (PAVE unit) based on a perfluoro(alkyl vinyl ether).

The perfluoro(alkyl vinyl ether) is not particularly limited, and examples thereof include a perfluoro unsaturated compound represented by the formula (1):

CF₂═CF—ORf¹ (1)

wherein Rf¹ represents a perfluoro organic group.

The term “perfluoro organic group” herein means an organic group in which all the hydrogen atoms bonded to carbon atoms are replaced with fluorine atoms. The perfluoro organic group may contain an oxygen atom which forms an ether bond.

The perfluoro(alkyl vinyl ether) is preferably, for example, a perfluoro unsaturated compound represented by the formula (1) in which Rf¹ represents a perfluoro alkyl group having 1 to 10 carbon atoms, more preferably 1 to 5 carbon atoms.

The perfluoro(alkyl vinyl ether) is more preferably at least one selected from the group consisting of perfluoro(methyl vinyl ether) [PMVE], perfluoro(ethyl vinyl ether) [PEVE], perfluoro(propyl vinyl ether) [PPVE], and perfluoro(butyl vinyl ether), still more preferably at least one selected from the group consisting of PMVE, PEVE, and PPVE, and particularly preferably PPVE in terms of excellent heat resistance.

The PFA contains a PAVE unit in an amount of preferably 1 to 10 mol %, and more preferably 3 to 6 mol %. The PFA preferably contains a TFE unit and a PAVE unit in a total amount of 90 to 100 mol % of all the polymer units.

The PFA may be a copolymer that contains a TFE unit, a PAVE unit, and a polymer unit based on a monomer copolymerizable with TFE and PAVE. Examples of the monomer copolymerizable with TFE and PAVE include hexafluoropropylene; vinyl monomers represented by CX¹X²═CX³(CF₂)ₙX⁴ (X¹, X², and X³ are the same as or different from one another and each individually represent a hydrogen atom or a fluorine atom; X⁴ represents a hydrogen atom, a fluorine atom, or a chlorine atom; and n represents an integer of 2 to 10); and alkyl perfluoro vinyl ether derivatives represented by CF₂═CF—OCH₂-Rf² (Rf² represents a perfluoro alkyl group having 1 to 5 carbon atoms). The monomer copolymerizable with TFE and PAVE is preferably at least one selected from the group consisting of hexafluoropropylene and alkyl perfluoro vinyl ether derivatives represented by CF₂═CF—OCH₂-Rf² (Rf² represents a perfluoro alkyl group containing 1 to 5 carbon atoms).

The alkyl perfluoro vinyl ether derivative is preferably one represented by CF₂═CF—OCH₂-Rf² in which Rf² represents a perfluoro alkyl group containing 1 to 3 carbon atoms, and more preferably one represented by CF₂═CF—OCH₂—CF₂CF₃.

If the PFA contains a polymer unit based on a monomer copolymerizable with TFE and PAVE, the PFA preferably contains a monomer unit based on the monomer copolymerizable with TFE and PAVE in an amount of 0 to 10 mol %, and a TFE unit and a PAVE unit in a total amount of 90 to 100 mol %. More preferably, the amount of the monomer unit based on the monomer copolymerizable with TFE and PAVE is 0.1 to 10 mol %, and the total amount of the TFE unit and the PAVE unit is 90 to 99.9 mol %. Too large an amount of the monomer unit copolymerizable with a TFE unit and a PAVE unit may deteriorate the adhesiveness between the layer (A) and the layer (B).

The PFA contains a carboxyl group at a terminus of a main chain. The PFA containing a carboxyl group at a terminus of the main chain enables firmer attachment between the layer (A) and the layer (B). The main chain of the PFA may contain a carboxyl group at either or both termini. The PFA preferably contains no carboxyl groups at the side chains.

The PFA preferably contains not less than 50 carboxyl groups per 10⁶ main chain carbon atoms. Such a number of carboxyl groups may further improve the adhesiveness between the layer (A) and the layer (B). The PFA more preferably contains not less than 80 carboxyl groups, and still more preferably contains not less than 100 carboxyl groups, per 10⁶ main chain carbon atoms.

The PFA has a melt flow rate (MFR) of not lower than 20 g/10 min. The MFR is preferably not lower than 30 g/10 min, and more preferably not lower than 60g/10min. The upper limit of the MFR is, for example, 100 g/10 min.

The MFR is measured at a temperature of 372° C. and a load of 5.0 kg in accordance with ASTM D 3307.

The PFA has a melting point of not higher than 295° C. The melting point is preferably 285° C. to 293° C., and more preferably 288° C. to 291° C. The melting point is the temperature at which the melting peak is observed when the temperature of the PFA is raised at a rate of 10° C./min using a DSC (differential scanning calorimeter).

The laminate of the present invention preferably further includes a layer (C) formed on the layer (B). The layer (C) is preferably a layer including at least one fluororesin selected from the group consisting of polytetrafluoroethylene (PTFE), polyvinylidene fluoride (PVdF), a tetrafluoroethylene/hexafluoropropylene copolymer (FEP), a tetrafluoroethylene/perfluoro(alkyl vinyl ether) copolymer (PFA), and an ethylene/tetrafluoroethylene copolymer (ETFE); more preferably a layer including at least one fluororesin selected from the group consisting of PTFE and PVdF; and still more preferably a layer including PTFE. Such a layer (C) achieves a low dielectric constant and a low dielectric loss tangent, enabling the resulting laminate to be suitably used for products for high frequency signal transmission.

The PTFE may be a tetrafluoroethylene homopolymer or a modified polytetrafluoroethylene [modified PTFE], as long as it can be fibrillated and has non-melt process ability. The term “modified PTFE” means a PTFE that is produced by copolymerization of tetrafluoroethylene and a comonomer in a small amount not imparting melt process ability to the resulting copolymer. The comonomer in a small amount is not particularly limited, and examples thereof include hexafluoropropylene, chlorotrifluoroethylene, trifluoroethylene, PAVE, perfluoro(alkoxy vinyl ether), and (perfluoro alkyl)ethylene. The comonomer in a small amount may be one or more of these.

The proportion (modified ratio) of the comonomer in a small amount added to the modified polytetrafluoroethylene depends on the kind of the comonomer, but for example, it is preferably not more than 1 mass %, and more preferably 0.001 to 1 mass %, of the total mass of the tetrafluoroethylene and the comonomer in a small amount.

The PTFE preferably has a melting point of not lower than 320° C. in terms of heat resistance.

The PTFE preferably has a standard specific gravity (SSG) of preferably 2.13 to 2.17. The SSG may be determined in accordance with ASTM D4895.

The PVdF substantially consists of only a polymer unit (VdF unit) based on VdF. However, the PVdF may further contain a polymer unit based on a monomer other than VdF as long as the amount of the monomer is not more than 1 mass %. Examples of such a monomer include TFE, HFP, CTFE, CF₂═CFH, and PAVE.

The layer (C) preferably includes at least one polymer selected from the group consisting of a TFE homopolymer and a modified PTFE polymer having a modified ratio of not more than 1 mass %, in terms of lowering the dielectric constant and the dielectric loss tangent.

The layer (B) and the layer (C) may contain additives such as inorganic pigments, fillers, adhesion-imparting agents, antioxidants, lubricants, and dyes. The inorganic pigments are preferably those stable in a molding process, such as titanium, iron oxides, and carbon powder. The above-mentioned inorganic pigments, fillers, adhesion-imparting agents, antioxidants, lubricants, and dyes may be included in either or both of the layer (B) and the layer (C).

The thicknesses of the layer (B) may vary depending on the usage, but is preferably 1 μm to 1 mm, and more preferably 1 to 100 μm, for example. Still more preferably, the thickness is not more than 60 μm, and particularly preferably not more than 40 μm.

If the laminate of the present invention includes the layer (C), the layer (C) has a thickness of preferably 25 μm to 1.5 mm.

The laminate of the present invention includes a layer (A) and a layer (B) firmly attached to each other, and thus is suitable for products such as printed circuit boards, coil wires, electric wires, and cables.

The laminate of the present invention enables a metal layer to attach to another layer without a surface roughening process and prevents adversely affecting high frequency transmission, and thus is particularly suitable for products for high frequency signal transmission. Examples of the products for high frequency signal transmission include printed circuit boards of products such as mobile phones, various computers, and communication devices; high frequency transmission cables such as coaxial cables, LAN cables, and flat cables; and products for high frequency signal transmission, such as casings and connectors of antennas. The term “product for high frequency signal transmission” means, for example, a product transmitting signals of not less than 500 MHz.

The laminate of the present invention is also suitable for motor coil wires and wires for push-pull cables, which are required to have firmer adhesiveness.

Particularly, the laminate of the present invention may be suitably used for printed circuit boards and high frequency transmission cables.

The laminate of the present invention may be produced by the following method, which is particularly suitable for a laminate used as a printed circuit board.

The present invention also provides a method of producing a laminate including a layer (A) including a metal and a layer (B) formed on the layer (A), including heat pressing a metal and a sheet, wherein the sheet includes a copolymer (PFAA) contains a polymer unit based on tetrafluoroethylene and a polymer unit based on a perfluoro(alkyl vinyl ether), the copolymer contains a carboxyl group at a terminus of a main chain and has a melt flow rate of not lower than 20 g/10 min and a melting point of not higher than 295° C., and the metal is at least one selected from the group consisting of copper, stainless steel, aluminum, iron, and an alloy thereof.

This method may further include, simultaneous with or subsequent to heat pressing the metal and the sheet including PFA, heat pressing a sheet including a fluororesin on the sheet including PFA. The fluororesin may be any one of those exemplified for the fluororesin forming the layer (C).

Preferable examples of the metal are the same as those exemplified above. If the laminate is a printed circuit board, the metal is preferably a metal foil.

Heat pressing may be performed by vacuum heat pressing, for example.

The temperature for heat pressing is preferably 290° C. to 380° C., and more preferably 320° C. to 350° C., for firmer attachment between the metal and the sheet including PFA.

The pressure for heat pressing is preferably 0.1 to 30 MPa, and more preferably 4 to 9 MPa, for firmer attachment between the metal and the sheet including PFA.

The method of the present invention may include stacking a metal, a sheet including PFA, and optionally a sheet including a fluororesin before heat pressing. The fluororesin may be any of those exemplified for the fluororesin forming the layer (C).

The method of producing the laminate of the present invention more preferably includes polymerizing tetrafluoroethylene and a perfluoro(alkyl vinyl ether) to produce a copolymer (PFA) that contains a polymer unit based on tetrafluoroethylene and a polymer unit based on a perfluoro(alkyl vinyl ether), contains a carboxyl group at a terminus of a main chain, and has a melt flow rate of not lower than 20 g/10 min and a melting point of not higher than 295° C.; forming the PFA into pellets including the PFA; forming the pellets into a sheet including PFA; and heat pressing the sheet and a metal that is at least one selected from the group consisting of copper, stainless steel, aluminum, iron, and an alloy thereof.

Polymerization for producing a PFA may be performed by any known method, such as suspension polymerization, solution polymerization, emulsion polymerization, and bulk polymerization. The polymerization may be performed under appropriate conditions (e.g. temperature, pressure), and additives may be appropriately used depending on the composition of or the amount of the desired PFA. Suspension polymerization is preferable among the mentioned polymerization methods.

For the polymerization for producing a PFA, a polymerization initiator may be used. Examples thereof include bis(fluoroacyl)peroxides such as (C₃F₇COO)₂; bis(chlorofluoroacyl)peroxides such as (CIC₂F₆COO)₂; diacyl peroxides such as diisobutyryl peroxide; dialkyl peroxydicarbonates such as diisopropyl peroxydicarbonate; peroxyesters such as tent-butyl peroxy isobutyrate and tert-butyl peroxy pivalate; persulfates such as ammonium persulfate; and azo initiators such as azobisisobutyronitrile. Such a polymerization initiator contributes to production of a PFA containing a carboxyl group at a terminus of a main chain.

For the polymerization for producing a PFA, a chain transfer agent may be used. Examples thereof include lower alcohols having 1 to 10 carbon atoms, hydrocarbon gases (e.g. methane, ethane, propane, butane), ethyl acetate, and acetone. The polymerization is, however, preferably performed without a chain transfer agent in terms of producing a PFA containing a carboxyl group at a terminus of a main chain.

The PFA may be formed into pellets by, for example, melt-kneading the PFA in a kneader and then taking out the pelletized copolymer from the kneader. The temperature for melt-kneading is preferably 330° C. to 380° C., and more preferably 340° C. to 370° C.

The pellets may be formed into a sheet by melt extrusion molding, heat pressing, vacuum heat pressing, or the like.

The laminate of the present invention may be suitably used for coil wires, electric wires, cables, and wires, and particularly suitably used for high frequency transmission cables. Examples of the high frequency transmission cables include coaxial cables; wiring of the antennas at mobile phone base stations; and winding wires for motors, transformers, and coils.

The laminate of the present invention is also suitable for wires used for motor coil wires and push-pull cables, which are required to have firm adhesiveness.

The high frequency transmission cables may be produced by a known method such as a method shown in JP 2001-357729 A or a method shown in JP 9-55120 A.

The coaxial cables typically contain an inner conductor, an insulating coating layer, an outer conductor layer, and a protective coating layer stacked in this order from the core to the outer periphery. The thickness of each layer is not particularly limited. Typically, the inner conductor has a diameter of about 0.1 to 3 mm, the insulating coating layer has a thickness of about 0.3 to 3 mm, the outer conductor layer has a thickness of about 0.5 to 10 mm, and the protective coating layer has a thickness of about 0.5 to 2 mm.

The laminate of the present invention includes a layer (A) and a layer (B) firmly attached to each other and thus may be suitably used as motor coil wires (e.g. motor coil wires used for various motors, such as motors for automobiles and motors for robots) that are required to have firm adhesiveness. A motor coil wire is thus another preferable aspect of the laminate of the present invention.

Push-pull cables are used in many devices such as automatic transmissions, mechanical latches, and hydraulic valve controls. The laminate of the present invention includes a layer (A) and a layer (B) firmly attached to each other and thus is suitable for wires for push-pull cables, which require firm adhesiveness. Thus, a push-pull cable including the laminate is another aspect of the present invention.

The laminate of the present invention may be produced by the following method, which is particularly suitable for a laminate used as a coil wire or a cable.

The present invention also provides a method of producing a laminate, including covering/molding a core wire including a metal with a copolymer, wherein the copolymer contains a polymer unit based on tetrafluoroethylene and a polymer unit based on a perfluoro(alkyl vinyl ether), the copolymer contains a carboxyl group at a terminus of a main chain and has a melt flow rate of not lower than 20 g/10 min and a melting point of not higher than 295° C., and the metal is at least one selected from the group consisting of copper, stainless steel, aluminum, iron, and an alloy thereof. Thereby, a coating layer including the PFA is formed on the core wire.

The covering/molding may be performed by dipping, extrusion molding, or wrapping. Melt extrusion molding is preferable because the layer (A) and the layer (B) can be firmly attached to each other.

The temperature for covering/molding is preferably 340° C. to 410° C., and more preferably 380° C. to 400° C., for firmer attachment between the core wire including a metal and the coating layer including a PFA.

The production method may include heat processing after covering/molding. The method of heat processing is not particularly limited, but is preferably a method enabling to control a temperature as accurate as possible because it may affect the characteristics of the resulting products. Examples thereof include a method using a hot air circulation furnace that easily adjusts the temperature of a resin to almost the same as a set temperature, and a method of immersing an extrusion molded cable in a molten salt bath to heat and fire the cable, namely, a salt bath method. Preferable examples of the molten salt to be used include a mixture of potassium nitrate and sodium nitrate at a mixing ratio of 1:1.

The temperature for heat processing is preferably 140° C. to 380° C., more preferably 200° C. to 380° C., still more preferably 280° C. to 360° C., and particularly preferably 300° C. to 350° C. Heat processing at a temperature within the above range enables firmer attachment between the layer (A) and the layer (B).

The production method may include polymerizing tetrafluoroethylene and a perfluoro(alkyl vinyl ether) to produce a copolymer (PFA) that contains a polymer unit based on tetrafluoroethylene and a polymer unit based on a perfluoro(alkyl vinyl ether) and has a melt flow rate of not lower than 20 g/10 min; forming the PFA into pellets including the PFA; and covering/molding a core wire including a metal with the PFA pellets, the metal being at least one selected from the group consisting of copper, stainless steel, aluminum, iron, and an alloy thereof.

The production method may further include coating the resulting laminate with PTFE after covering/molding.

If the laminate of the present invention includes a layer (C) that includes PTFE, the layer (C) may be formed by paste extrusion or by extrusion molding a dispersion of the primary particles of polytetrafluoroethylene, as shown in WO 2008/102878.

### EXAMPLES

Next, the present invention is described referring to examples, which are not intended to limit the present invention.

The values in the examples were determined by the following methods.

### (Composition of Polymer)

The compositions of polymers were determined by ¹⁹F-NMR.

(Number of Carboxyl Groups)

A test sample was compression molded at 350° C. into a film with a thickness of 0.25 to 0.3 mm. This film was scanned 40 times with a Fourier transform infrared spectrometer (FT-IR) (product name: type 1760X, produced by Perkin Elmer Japan Co., Ltd.), followed by analyzing the obtained data to obtain an infrared absorption spectrum. Then, a difference spectrum between the obtained infrared absorption spectrum and a base spectrum of one that was completely fluorinated and had no terminal groups was obtained. From the absorption peak of carboxyl groups shown in this difference spectrum, the number (N) of carboxyl groups per 1×10⁶ carbon atoms of the test sample was calculated using the following formula.

N=I×K/t

I: absorbance

K: correction factor

t: thickness of film (mm)

Table 1 shows the absorption frequency, the molar extinction coefficient, and the correction factor of the carboxyl groups in the present description, for reference. Here, the molar extinction coefficient was determined from the FT-IR measurement data of a low molecular weight model compound.

TABLE 1

| | | Molar | | |
|---|---|---|---|---|
| | Absorption | extinction | | |
| | frequency | coefficient | Correction | Model |
| Terminal group | (cm⁻¹) | (l/cm/mol) | factor | compound |
| COOH (free) | 1815 | 530.0 | 439 | H(CF₂)₆COOH |
| COOH (bonded) | 1779 | 530.0 | 439 | H(CF₂)₆COOH |

### (MFR)

The MFR was determined by measuring the mass (g) of the polymer flowed from a nozzle (diameter: 2 mm, length: 8mm) per unit time (10 min) at a temperature of 372° C. and a load of 5 kg using a melt indexer (produced by TOYO SEIKI Co., Ltd.) in accordance with ASTM D 3307.

### (Melting Point)

The melting point is a temperature corresponding at which the melting peak is observed when the temperature was raised at a rate of 10° C./min using a DSC device.

### Example 1

A PFA (composition: TFE/PPVE=97.2/2.8 (molar ratio), MFR: 70.2 g/10 min, melting point: 290° C., number of carboxyl groups at terminuses of main chains: 115 groups per 10⁶ main chain carbon atoms) in an amount of 9.5 g was prepared and surrounded by spacers of 0.5 mm such that the spacers formed a quadrangle (11 cm×8 cm). The PFA was heat pressed at a temperature of 350° C., a preheating time of 600 sec, a pressure of 10.2 MPa, and a pressure time of 120 sec in a vacuum heat press machine (type: MKP-1000HV-WH-S7, produced by Mikado Technos Co., Ltd.) to produce a PFA sheet (sample A, thickness: 0.5 mm). Table 2 shows the conditions for sample production.

The sample A was attached to a copper foil (thickness: 0.8 mm) by heat pressing under the conditions shown in Table 3 in the vacuum heat press machine, thereby producing a laminate.

### Example 2

A PFA (composition: TFE/PPVE=97.9/2.1 (molar ratio), MFR: 24.7 g/10 min, melting point: 294° C., number of carboxyl groups at terminuses of main chains: 80 groups per 10⁶ main chain carbon atoms) in an amount of 9.5 g was prepared and surrounded by spacers of 0.5 mm such that the spacers formed a quadrangle (11 cm×8 cm). The PFA was heat pressed at a temperature of 350° C., a preheating time of 600 sec, a pressure of 10.2 MPa, and a pressure time of 120 sec in a vacuum heat press machine (type: MKP-1000HV-WH-S7, produced by Mikado Technos Co., Ltd.) to produce a PFA sheet (sample B, thickness: 0.5 mm). Table 2 shows the conditions for sample production.

The sample B was attached to a copper foil (thickness: 0.8 mm) by heat pressing under the conditions shown in Table 3 in the vacuum heat press machine, thereby producing a laminate.

### Comparative Example 1

A PFA (composition: TFE/PPVE=98.5/1.5 (molar ratio), MFR: 14.8 g/10 min, melting point: 305° C., number of carboxyl groups at terminuses of main chains: 21 groups per 10⁶ main chain carbon atoms) in an amount of 9.6 g was prepared and surrounded by spacers of 0.5 mm such that the spacers formed a quadrangle (11 cm×8 cm). The PFA was heat pressed at a temperature of 350° C., a preheating time of 600 sec, a pressure of 10.2 MPa, and a pressure time of 120 sec in the same vacuum heat press machine (type:MKP-1000HV-WH-S7, produced by Mikado Technos Co., Ltd.) as in Example 1 to produce a PFA sheet (sample C, thickness: 0.5 mm). Table 2 shows the conditions for sample production.

The sample C was attached to a copper foil (thickness: 0.8 mm) by heat pressing under the conditions shown in Table 3 in the vacuum heat press machine, thereby producing a laminate.

### Comparative Example 2

A PFA (composition: TFE/PPVE=98.5/1.5 (molar ratio), MFR: 2.2 g/10 min, melting point: 307° C., number of carboxyl groups at terminuses of main chains: 9 groups per 10⁶ main chain carbon atoms) in an amount of 9.6 g was prepared and surrounded by spacers of 0.5 mm such that the spacers formed a quadrangle (11 cm×8 cm). The PFA was heat pressed at a temperature of 350° C., a preheating time of 600 sec, a pressure of 10.2 MPa, and a pressure time of 120 sec in the same vacuum heat press machine as in Example 1 to produce a PFA sheet (sample D, thickness: 0.5 mm). Table 2 shows the conditions for sample production.

The sample D was attached to a copper foil (thickness: 0.8 mm) by heat pressing under the conditions shown in Table 3 in the vacuum heat press machine, thereby producing a laminate.

TABLE 2

| | | | Number of | | | | |
|---|---|---|---|---|---|---|---|
| | | | —COOH | Pressing | Preheating | | Pressure |
| | | MFR | functional groups | temperature | time | Pressure | time |
| | Sample | (g/10 min) | (per 10⁶C) | (° C.) | (sec) | (MPa) | (sec) |
| Example 1 | A | 70.2 | 115 | 350 | 600 | 10.2 | 120 |
| Example 2 | B | 24.7 | 80 | | | | |
| Comparative | C | 14.8 | 21 | | | | |
| Example 1 | | | | | | | |
| Comparative | D | 2.2 | 9 | | | | |
| Example 2 | | | | | | | |

TABLE 3

| | | Pressing | Preheating | | Pressure |
|---|---|---|---|---|---|
| | | time | time | Pressure | time |
| | Sample | (° C.) | (sec) | (MPa) | (sec) |
| Example 1 | A | 350 | 0 | 5.7 | 120 |
| Example 2 | B | | | | |
| Comparative | C | | | | |
| Example 1 | | | | | |
| Comparative | D | | | | |
| Example 2 | | | | | |

### (Peeling Test)

Concerning each laminate including a copper foil and one of the samples A to D obtained in the examples and the comparative examples, the integrated average, the average of local maxima, and the maximum point of the peeling strength were determined by the following methods, thereby evaluating the adhesiveness.

### Method for Determining Peeling Strength

The laminate was cut into a width of 25 mm, folded to make a T shape, and then peeled off at an end to prepare a test piece for a peeling test.

The peeling strength of the test piece was determined at room temperature and a crosshead speed of 50 mm/min using a Tensilon universal tester produced by Shimadzu Corporation by an area method in accordance with the T-peel test method shown in JIS K 6854-3-1999.

### (Integrated Average)

The integrated average was calculated as the average load in the measurement interval.

### (Average of Local Maxima)

The average of local maxima was calculated as the average load of maxima in the measurement interval.

### (Maximum Point)

The maximum point was obtained as the maximum load point in the measurement interval.

Table 4 shows the results.

TABLE 4

| | | | | Number of | | | |
|---|---|---|---|---|---|---|---|
| | | | Melting | —COOH | Integrated | Average of | Maximum |
| | | MFR | point | functional groups | average | local maxima | point |
| | Sample | (g/10 min) | (° C.) | (per 10⁶C) | (N/cm) | (N/cm) | (N) |
| Example 1 | A | 70.2 | 290 | 115 | 36.1 | 36.4 | 38 |
| Example 2 | B | 24.7 | 294 | 80 | 28 | 28.4 | 31.5 |
| Comparative | C | 14.8 | 305 | 21 | 19.8 | 21.3 | 26.7 |
| Example 1 | | | | | | | |
| Comparative | D | 2.2 | 307 | 9 | 17.6 | 17.9 | 19.4 |
| Example 2 | | | | | | | |

### Example 3

A PFA (composition: TFE/PPVE=97.2/2.8 (molar ratio), MFR: 70.2 g/10 min, melting point: 290° C., number of carboxyl groups at terminuses of main chains: 80 groups per 10⁶ main chain carbon atoms), was melt processed on an uncoated copper wire (diameter: 1.0 mm) using a die (inner diameter: 7 mm, die temperature: 390° C.) and a tip (inner diameter: 3 mm, outer diameter: 6 mm) at a linear velocity of 10 m/min. The resulting product was brought back to room temperature, thereby producing a PFA-coated copper wire (outer diameter: 1.14 mm). Then, the PFA-coated copper wire was passed through a circulating hot air oven (length: 8 m, temperature: 330° C.) for two minutes (4 m/min), thereby producing a PFA-coated copper wire having an adhesion strength to the core wire of not less than 5 kg/3 inch.

The adhesion strength to the core wire is the tensile force of pulling out the coating at 12.7 mm/min, in accordance with a method shown in MIL C-17.

### Example 4

A PFA (composition: TFE/PPVE=97.9/2.1 (molar ratio), MFR: 24.7 g/10 min, melting point: 294° C., number of carboxyl groups at terminuses of main chains: 80 groups per 10⁶ main chain carbon atoms) was heated by gas heating and melt processed on an uncoated copper wire (diameter: 1.0 mm) using a die (inner diameter: 7 mm, die temperature: 390° C.) and a tip (inner diameter: 3 mm, outer diameter: 6 mm) at a linear velocity of 10 m/min while the temperature was kept at 330° C. or higher. The resulting product was brought back to room temperature, thereby producing a PFA-coated copper wire (outer diameter: 1.14 mm). Then, the PFA-coated copper wire was passed through a circulating hot air oven (length: 8 m, temperature: 330° C.) for two minutes (4 m/min), thereby producing a PFA-coated copper wire having an adhesion strength to the core wire of not less than 3 kg/3 inch. The adhesion strength to the core wire was determined in the same manner as in Example 3.

### Comparative Example 3

A PFA (composition: TFE/PPVE=98.5/1.5 (molar ratio), MFR: 14.8 g/10 min, melting point: 305° C., number of carboxyl groups at terminuses of main chains: 80 groups per 10⁶ main chain carbon atoms) was melt processed on an uncoated copper wire (diameter: 1.0 mm) using a die (inner diameter: 7 mm, die temperature: 390° C.) and a tip (inner diameter: 3 mm, outer diameter: 6 mm) at a linear velocity of 10 m/min. The resulting product was brought back to room temperature, thereby producing a PFA-coated copper wire (outer diameter: 1.14 mm). Then, the PFA-coated copper wire was passed through a circulating hot air oven (length: 8 m, temperature 330° C.) for two minutes (4 m/min), thereby producing a PFA-coated copper wire having an adhesion strength to the core wire of 0.1 kg/3 inch. The adhesion strength to the core wire was determined in the same manner as in Example 3.

### Example 5

A copper foil (thickness: 0.8 mm) and the sample A obtained in Example 1 were stacked. The resulting product was surrounded by spacers of 1 mm such that the spacers formed a quadrangle (11 cm×8 cm) and heat pressed at a temperature of 350° C., a preheating time of 0 sec, a pressure of 10.2 MPa, and a pressure time of 90 sec in a vacuum heat press machine to produce a laminate. Then, a PTFE sheet (thickness: 0.5mm) was placed on the sample A of the laminate. The resulting product was surrounded by spacers of 1.5 mm and heat pressed at a temperature of 350° C., a preheating time of 0 sec, a pressure of 5.7 MPa, and a pressure time of 90 sec in a vacuum heat press machine to produce a laminate of Cu/PFA/PTFE. The adhesive strength between the PFA and the PTFE of the laminate was 41.0 N/cm.

The adhesive strength was determined in the same manner as in the above peeling test and calculated as the integrated average in the measurement interval.

### Example 6

A copper foil (thickness: 0.8mm), the sample A obtained in Example 1, and a PTFE sheet (thickness: 0.5mm) were stacked. The resulting product was surrounded by spacers of 1.5 mm such that the spacers formed a quadrangle (11 cm×8 cm) and heat pressed at a temperature of 350° C., a preheating time of 0 sec, a pressure of 5.7 MPa, and a pressure time of 90 sec in a vacuum heat press machine to produce a laminate of Cu/PFA/PTFE. The adhesive strength between the PFA and the PTFE of the laminate was 17.3 N/cm.

The adhesive strength was determined in the same manner as in Example 5.

### INDUSTRIAL APPLICABILITY

The laminate of the present invention may be suitably used for printed circuit boards of mobile phones, various computers, and communication devices; high frequency cables such as coaxial cables, LAN cables, and flat cables; motor coil wires, electric wires, and push-pull cables; and products for high frequency signal transmission such as casings and connectors of antennas.

1. A laminate comprising:
a layer (A) comprising a metal, and
a layer (B) formed on the layer (A),
wherein the layer (B) comprises a copolymer containing a polymer unit based on tetrafluoroethylene and a polymer unit based on a perfluoro(alkyl vinyl ether),
the copolymer contains a carboxyl group at a terminus of a main chain and has a melt flow rate of not lower than 20 g/10 min and a melting point of not higher than 295° C., and
the metal is at least one selected from the group consisting of copper, stainless steel, aluminum, iron, and an alloy thereof.

2. The laminate according to claim 1,
wherein the copolymer contains not less than 50 carboxyl groups per 10⁶ main chain carbon atoms.

3. The laminate according to claim 1, further comprising a layer (C) formed on the layer (B),
wherein the layer (C) comprises at least one polymer selected from the group consisting of a tetrafluoroethylene homopolymer and a modified polytetrafluoroethylene having a modified ratio of not more than 1 mass %.

4. The laminate according to claim 1, wherein the laminate is a printed circuit board.

5. The laminate according to claim 1, wherein the laminate is a motor coil wire.

6. A push-pull cable, comprising the laminate according to claim 1.

7. A method of producing a laminate, comprising
heat pressing a metal and a sheet,
wherein the sheet comprises a copolymer containing a polymer unit based on tetrafluoroethylene and a polymer unit based on a perfluoro(alkyl vinyl ether),
the copolymer contains a carboxyl group at a terminus of a main chain and has a melt flow rate of not lower than 20 g/10 min and a melting point of not higher than 295° C., and
the metal is at least one selected from the group consisting of copper, stainless steel, aluminum, iron, and an alloy thereof.

8. A method of producing a laminate, comprising
covering/molding a core wire comprising a metal with a copolymer,
wherein the copolymer contains a polymer unit based on tetrafluoroethylene and a polymer unit based on a perfluoro(alkyl vinyl ether),
the copolymer contains a carboxyl group at a terminus of a main chain and has a melt flow rate of not lower than 20 g/10 min and a melting point of not higher than 295° C., and
the metal is at least one selected from the group consisting of copper, stainless steel, aluminum, iron, and an alloy thereof.
